(19) United States
(12) Patent Application Publication
(10) Pub. No.: US 2009/0225221 A1
(43) Pub. Date: Sep. 10, 2009

(54) FLEXIBLE ROUTER

(76) Inventors: Andrew Robert Gordon, Cambridge (GB); John Savage, Montreal (CA); David Haines, Markham (CA)

Correspondence Address: DLA PIPER LLP US, P. O. BOX 2758, RESTON, VA, 20195, US

(21) Appl. No.: 12/051,379

(22) Filed: Mar. 19, 2008

Related U.S. Application Data
(60) Provisional application No. 61/033,634, filed on Mar. 4, 2008.

(51) Int. Cl. H04N 7/01

(52) U.S. Cl. 348/441; 348/E07.003

(57) ABSTRACT

A method and apparatus are disclosed for providing a video signal to anyone of a plurality of TV sets, the apparatus comprising at least one demodulation unit, each of the at least one demodulation unit for receiving one of a broadband signal and a broadcast signal and for providing a corresponding demodulated video signal, a modulating unit for modulating an incoming video signal into a video signal suitable for a given TV set and a switching unit for selecting a demodulated video signal from a given demodulation unit of the at least one demodulation unit and for providing the selected demodulated video signal to the modulating unit according to a selection signal.

### CROSS REFERENCE TO RELATED APPLICATION

This patent application claims priority of U.S. Provisional patent application No 61/033,634, entitled “Flexible router” that was filed on Mar. 4, 2008, which is hereby incorporated by reference.

### FIELD OF THE INVENTION

The invention relates to multimedia content delivery systems. More precisely, this invention pertains to a flexible router for providing a video signal to anyone of a plurality of TV sets.

### BACKGROUND OF THE INVENTION

Broadcast sources, such as cable or satellite, have been traditionally very popular amongst users for providing entertainment resources. For a monthly fee, a user is capable of accessing those sources.

Recently, due to the decrease of the cost of bandwidth, many broadband sources have become more and more popular and are now viable sources to provide new entertainment resources. Websites such as Youtube,™Dailymotion™ and others are delivering a large amount of content.

End users are unfortunately dependant on current generation equipment to access and view this content. Currently, this is typically a personal computer connected to the Internet. This can become cumbersome for some less experienced users. Moreover and due to technical limitations, such as the size of the screen, the experience of viewing those sources of content may be sometimes limited, and certainly does not compare with the viewing experience and comfort of watching this content on a television.

Moreover, since the technology is evolving towards delivering digital content, much legacy equipment is now becoming obsolete. A user may therefore have analog TV sets that become now useless or require a converter which is not desirable. A large amount of legacy TV sets will be disposed of before their mechanical life is completed which is not desirable.

There is therefore a significant gap between the ability for traditional television broadcasters and cable MSOs to deliver content in a restricted but high quality manner, and the ability for broadband providers to deliver an almost limitless variety of content but without the ability to do so to efficiently to legacy installed televisions.

There is a need for a method and apparatus that will overcome at least one of the above-identified drawbacks.

Features of the invention will be apparent from review of the disclosure, drawings and description of the invention below.

### BRIEF SUMMARY OF THE INVENTION

The invention provides a flexible router for providing a video signal to anyone of a plurality of TV sets, the flexible router comprising at least one demodulation unit, each of the at least one demodulation unit for receiving one of a broadband signal and a broadcast signal and for providing a corresponding demodulated video signal, a modulating unit for modulating an incoming video signal into a video signal suitable for a given TV set and a switching unit for selecting a demodulated video signal from a given demodulation unit of the at least one demodulation unit and for providing the selected demodulated video signal to the modulating unit according to a selection signal.

The invention further provides a method for providing a video signal to anyone of a plurality of TV sets, the method comprising receiving an incoming signal, the incoming signal being one of a broadband signal and a broadcast signal, processing the incoming signal to provide a video signal, modulating the video signal to provide a modulated video signal and providing the modulated video signal to at least one of a plurality of TV sets.

In the following a broadband signal is intended to mean a signal delivered on a broadband communication network.

### BRIEF DESCRIPTION OF THE DRAWINGS

In order that the invention may be readily understood, embodiments of the invention are illustrated by way of example in the accompanying drawings.

FIG. 1 is a diagram which shows one embodiment where a flexible router is advantageously used.

FIG. 2 is a block diagram which shows a first embodiment of a flexible router wherein the flexible router comprises a plurality of demodulation units.

FIG. 3 is a block diagram which shows a second embodiment of a flexible router wherein the flexible router comprises a plurality of demodulation units, a broadband data processing unit and a data storage unit.

FIG. 4 is a block diagram which shows a third embodiment of a flexible router wherein the flexible router comprises a plurality of demodulation units, a plurality of video processing units and a plurality of modulating units.

FIG. 5 is a flow chart which shows how the flexible router operates according to an embodiment.

FIG. 6 is a flow chart which shows how the flexible router operates in the case where the incoming signal originates from a digital broadcast source, such as cable.

FIG. 7 is a flow chart which shows how the flexible router operates in the case where the incoming signal originates from an analog broadcast source, such as cable.

FIG. 8 is a flow chart which shows how the flexible router operates in the case where the incoming signal originates from a data storage unit.

FIG. 9 is a flow chart which shows how the flexible router operates in the case where the incoming signal originates from a digital broadcast source. In this embodiment, the plurality of TV sets comprises analog TVs.

FIG. 10 is a flow chart which shows how the flexible router operates in the case where the incoming signal originates from an analog broadcast source and in the case where the plurality of TV sets comprises analog TV sets

FIG. 11 is a flow chart which shows how the flexible router operates in the case where the incoming signal originates from a data storage unit and in the case where the plurality of TV sets comprises analog TV sets.

FIG. 12 is a flow chart which shows how the flexible router operates in the case where the incoming signal originates from a broadband source, such as the Internet, and in the case where the plurality of TV sets comprises analog TV sets.

FIG. 13 is a flow chart which shows how the flexible router operates in the case where the incoming signal originates from a broadband source such, as the Internet, and in the case where the plurality of TV sets comprises digital TV sets.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

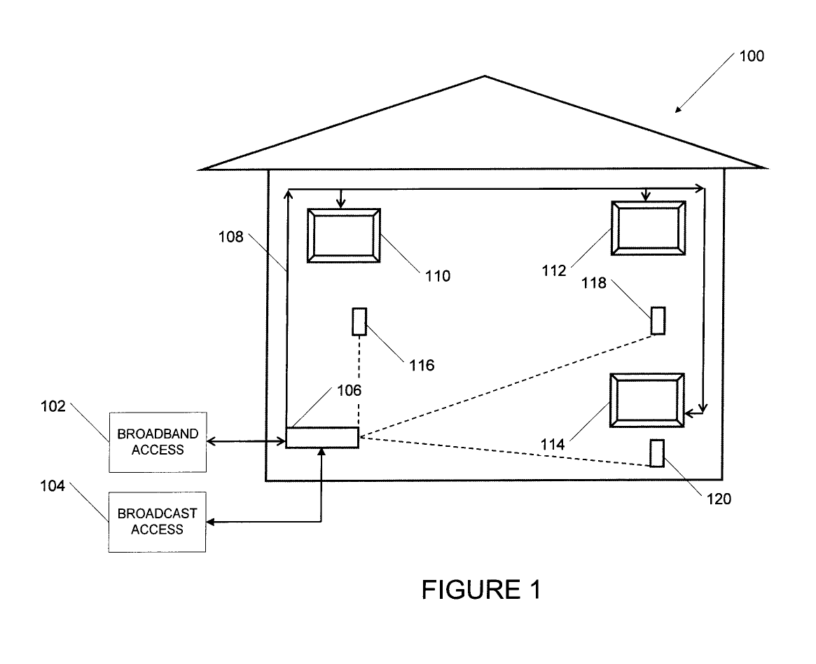

Now referring to FIG. 1, there is shown one embodiment in which a flexible router 106 is used. More precisely, the flexible router 106 is connected to a broadband access 102 and to a broadcast access 104. The flexible router 106 is further connected to a first TV set 110, to a second TV set 112 and to a third TV set 114 via an existing communication network 108.

The first TV set 110 is controlled using a remote control 116 while the second TV set 112 is controlled by a second remote control 118 and the third TV set is controlled by a remote control 120. The first TV set 110, the second TV set 112 and the third TV set 114 may be selected from a group of consisting of analog TV sets and digital TV sets as explained below and may comprise equipment required for providing a connection to the existing communication network 108. It will be appreciated that each of the first TV set 110, the second TV set 112 and the third TV set 114 are located at various locations of a house 100.

The broadband access 102 provides a broadband signal that may be delivered to any type of devices suitable for receiving the broadband signal such as xDSL modem, cable modem, satellite modem or the like.

Similarly, the broadcast access 104 provides a broadcast signal that may be delivered to any type of device suitable for receiving the broadcast signal such as xDSL modem, cable tuner, satellite modem or the like.

The flexible router 106 is used for providing a video signal to at least one of the first TV set 110, the second TV set 112 and the third TV set 114 using an existing communication network 108 of the house 100.

In one embodiment, the existing communication network 108 of the house 100 comprises a coaxial network to which each of the first TV set 110, the second TV set 112 and the third TV set 114 is connected. The skilled addressee will appreciate that in an alternative embodiment, another type of existing communication network may be provided.

The video signal provided by the flexible router 106 may originate from at least one of the broadband access 102 and the broadcast access 104 as further explained below. The remote controls 116, 118 and 114 are operatively connected to the flexible router 106 and are used to control respectively the first TV set 110, the second TV set 112 and the third TV set 114. It will be appreciated by the skilled addressee that while three TV sets have been shown in this drawing, many various configurations may be provided as further explained below.

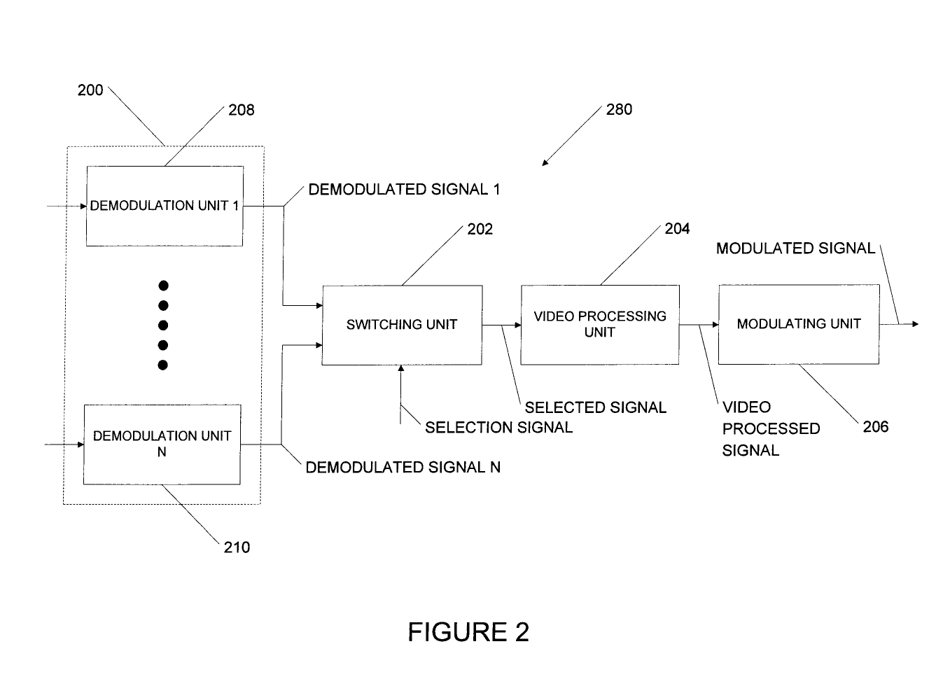

Now referring to FIG. 2, there is shown a first embodiment of the flexible router 280. In this embodiment, the flexible router 280 comprises at least one demodulation unit 200, a switching unit 202, a video processing unit 204 and a modulating unit 206.

The at least one demodulation unit 200 comprises a first demodulation unit 208 and an N^{th} demodulation unit 210. Each of the at least one demodulation unit 200 is connected to the switching unit 202. More precisely, each demodulation unit of the at least one demodulation unit 200 receives a video signal to demodulate and provides a corresponding demodulated video signal to the switching unit 202. The video signal to demodulate may originate from at least one of a broadband access and a broadcast access. It will be appreciated that each demodulation unit operates depending on the source providing the video signal.

The switching unit 202 is used to select a demodulated video signal of the at least one demodulated video signal provided by the at least one demodulation unit 200 according to a selection signal. The selection signal may be provided by a user or the router 280 itself and may be based on a criterion.

The video processing unit 204 is used to process an incoming video signal and to provide a video processed signal. In an alternative embodiment, no video processing is performed. In the embodiment shown in FIG. 2, the video processing unit 204 receives the selected signal from the switching unit 202 and provides a video processed signal. The processing of the incoming video signal may comprise adding graphics, removing at least one part of the video signal or the like or resizing the incoming video signal to meet specific requirements. The skilled addressee will appreciate that the video processing unit 204 may be advantageously used for inserting ads for instance. The skilled addressee will also appreciate that the video processing unit 204 may be used to combine broadband content with a broadcast programme to generate a personalized version of that programme.

The modulating unit 206 is used to modulate an incoming signal and to provide a modulated signal. In the embodiment shown in FIG. 2, the modulating unit 206 is used to receive a video signal and to provide a modulated signal. Alternatively, many other standards may be implemented.

It will be appreciated by the skilled addressee that the modulating unit 206 operates according to a standard used by the plurality of TV sets to which the modulated signal is delivered to. In the embodiment shown in FIG. 2, the modulating unit is used to receive the processed video signal and provide a modulated signal to a particular standard. Many different modulation schemes may be implemented as alternatives.

A user may switch the TV on the given channel to view the video signal. It will therefore be appreciated by the skilled addressee that a given channel may be used to display a video signal originating from a streaming video of the broadband access which is of great advantage as explained further below.

As mentioned previously, the modulated signal is delivered to the plurality of TV sets via the existing communication network 108.

It will be appreciated that in one embodiment the combination of a demodulation unit 200 with the modulating unit 206 enables the transcoding of an incoming signal having a format selected for example from a group consisting of MPEG2 HD, MPEG2 SD, MPEG4 HD, MPEG4 SD, Windows Media/SMPTE VC1, HTML & Streaming video into a modulated signal having a format selected from a group consisting of ATSC, J. 83 QAM and Analog.

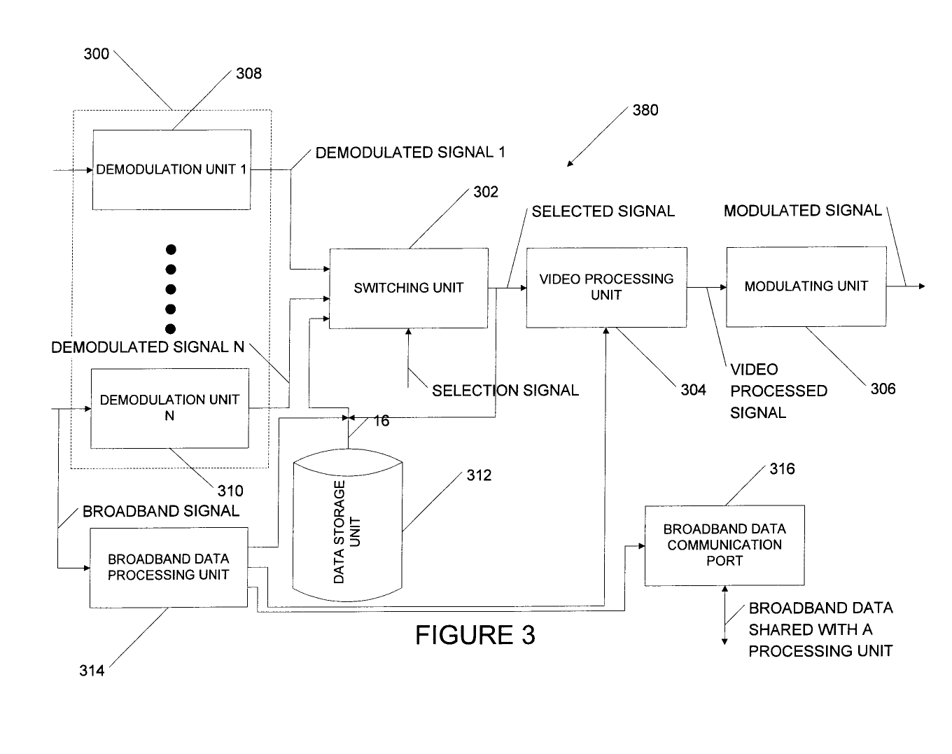

Now referring to FIG. 3, there is shown another embodiment of a flexible router 380.

In this embodiment, the flexible router 380 comprises a plurality of demodulation units 300, a switching unit 302, a video processing unit 304, a modulating unit 306, a data storage unit 312, a broadband data processing unit 314 and a broadband data communication port 316.

The plurality of demodulation units 300 comprises a first demodulation unit 308 and an N^{th} demodulation unit 310. Each of the plurality of demodulation units 300 receives a corresponding video signal to demodulate and provides a corresponding demodulated signal. The video signal to demodulate may originate from one of a broadband access and a broadcast access.

The switching unit 302 is used to select a demodulated signal and receives each of the demodulated signals as well as a signal originating from the data storage unit 312.

It will be appreciated that the switching unit 302 operates according to a selection signal and provides at least one corresponding selected signal. The selection signal may be provided by a user or the router 380 itself and may be based on a criterion. The at least one corresponding selected signal may be provided to at least one of the video processing unit 304 and the data storage unit 312.

The video processing unit 304 is used to process an incoming video signal. It receives at least one of the at least one selected signal from the switching unit 302 and provides a video processed signal to the modulating unit 306 in accordance with a video processing unit control signal.

It will be appreciated that in this embodiment the video processing unit 304 may be operated according to the video processing unit control signal provided in the broadband signal. In such embodiment, the video processing unit 304 may perform additional processing based upon data delivered over the broadband communication network. The data may comprise text, graphics and formatting instructions.

The modulating unit 306 is used to modulate a video signal and receives in this embodiment a video processed signal from the video processing unit 304 and provides a corresponding modulated signal. It will be appreciated by the skilled addressee that the modulating unit 306 operates according to a standard used by the plurality of TV sets to which the modulated signal is delivered.

The data storage unit 312 is used to store data which may originate from the broadband data processing unit 314 as well as from the switching unit 302 as explained above. It will be appreciated that the data may be stored in various formats depending on various design considerations known to the skilled addressee.

Moreover, it will be appreciated by the skilled addressee that the data storage unit 312 may be implemented in various forms. It will be appreciated that the data storage unit 312 may be advantageously used to store a video signal. In such case, the data storage unit 312 may be used to implement a Personal Video Recorder (PVR) which provides functions such as saving, fast forwarding, rewinding, and replaying video content to any room in the home, regardless of which room the content was originally watched in.

The broadband data communication port 316 is used to provide a connection from the flexible router 380 to another processing unit such as a desktop computer, a laptop computer, an external data router or the like. More precisely, the broadband data communication port 316 may be used to share the broadband access with the other processing units in the home or provide other functionalities to the flexible router 380.

The skilled addressee will appreciate that the broadband data communication port 316 may comprise, in one embodiment, any one of a wire communication port and a wireless communication port. In one embodiment, the communication port 316 comprises a WIFI port (IEEE 802.11x). Alternatively, the communication port 316 comprises an Ethernet port as well. It will be appreciated that in one embodiment, the broadband data communication port 316 may be used to provide VoIP capabilities.

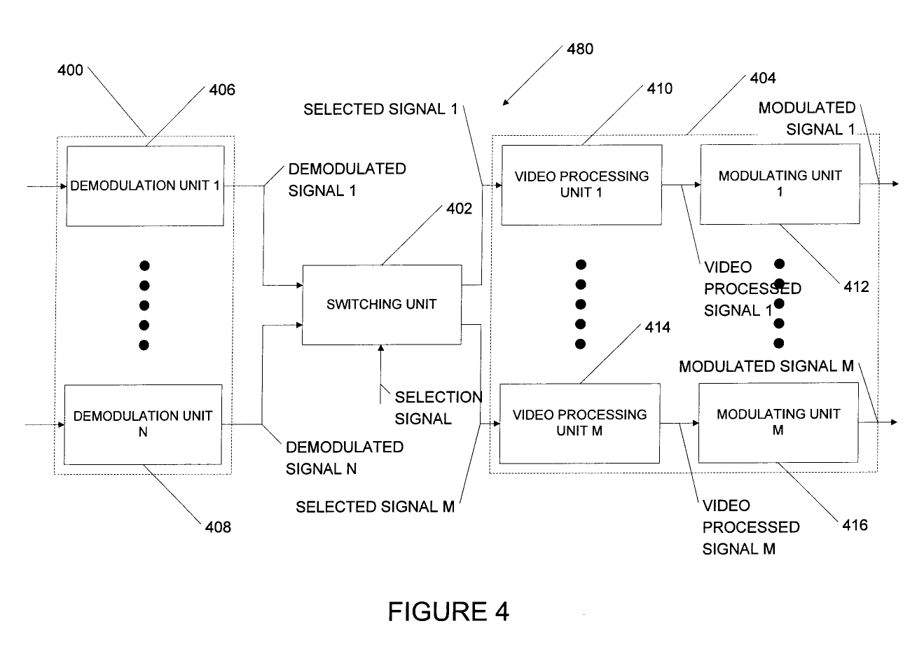

Now referring to FIG. 4, there is shown a further embodiment of a flexible router 480.

In this embodiment, the flexible router 480 comprises a plurality of demodulation units 400, a switching unit 402 and a plurality of video processing units and modulating units 404.

More precisely, the plurality of demodulation units 400 comprises demodulation unit 1406 and demodulation unit N 408.

The plurality of video processing units and modulating units comprise a first video processing unit 410 and a first modulating unit 412 and an M^{th} video processing unit 414 and an M^{th} modulating unit 416.

Each of the demodulation units of the plurality of demodulation units 400 is used to demodulate an incoming video signal and to provide a corresponding demodulated signal. The video signal to demodulate may originate from one of a broadband access and a broadcast access.

The switching unit 402 is used to receive each of the corresponding demodulated signals from the plurality of demodulation units 400 and to provide at least one of them to a corresponding video processing unit of the plurality of video processing units and modulating units 404.

The switching unit 402 operates according to a selection signal and provides a corresponding selected signal. The selection signal may be provided by a user or the router 480 itself and may be based on a criterion.

A selected signal 1 may be provided to the first video processing unit 410 which will perform processing on the incoming video signal and provide a video processed signal to a corresponding modulating unit 412. The modulating unit 412 will modulate the video processed signal 1 to provide a modulated signal 1. A selected signal M may be provided to the M video processing unit 404 which will perform a processing on the selected signal M and provide a video processed signal M to a corresponding M modulating unit 416. The modulating unit 416 will receive the video processed signal M and provide a corresponding modulated signal M. It will be appreciated by the skilled addressee that the modulating units 412 and 416 operate according to a standard used by the plurality of TV sets to which each corresponding modulated signal is delivered.

It will be appreciated by the skilled addressee that the modulated signal 1 and the modulated signal M are provided to the plurality of TV sets via the existing communication network.

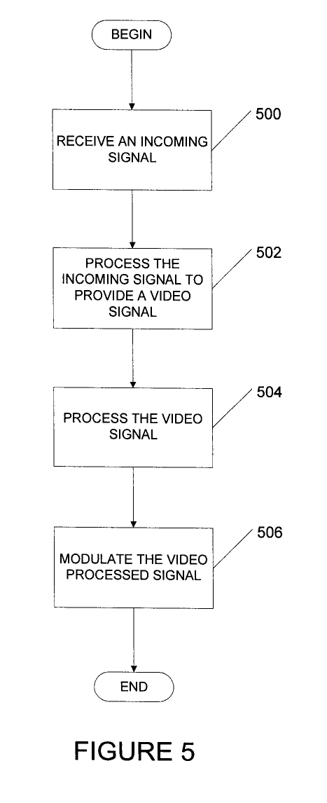

Now referring to FIG. 5, there is shown one embodiment which shows how the flexible router operates.

According to step 500, an incoming signal is received. It will be appreciated by the skilled addressee that the incoming signal may be received from at least one of the broadband access and the broadcast access.

According to step 502, the incoming signal is processed to provide a video signal. It will be appreciated by the skilled addressee that the processing of the incoming signal to provide a video signal may be performed according to various embodiments which are disclosed further below.

According to step 504, the video signal is processed. It will be appreciated by the skilled addressee that the processing of the video signal may be performed according to various embodiments and may depend on various applications. It will be further appreciated that this step may be optional in the case where no modification is desired for the video signal.

According to step 506, the video processed signal is modulated. The video processed signal is modulated in accordance with the type of TV sets to which the video processed signal is to be provided. It will be appreciated that various configurations may be provided for the modulation, some of which are further described below.

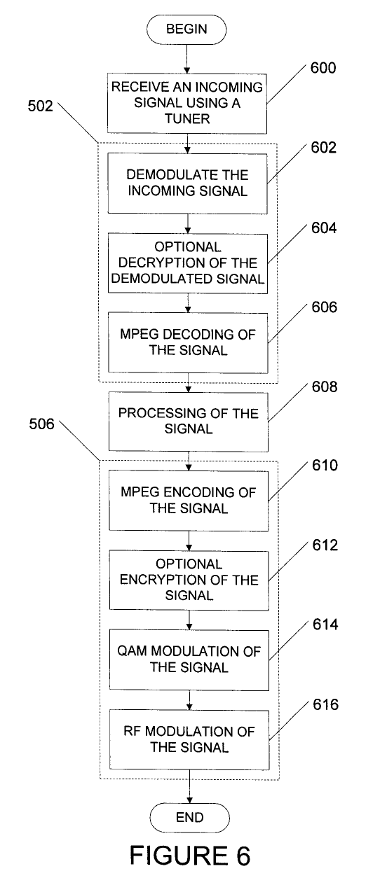

Now referring to FIG. 6, there is shown a first embodiment which shows how the flexible router operates in the case where the incoming signal originates from a digital broadcast source, such as cable.

According to step 600, an incoming signal is received using a tuner.

According to step 602, the incoming signal is demodulated. It will be appreciated that the demodulation is performed depending on the type of tuner used. In one embodiment, the demodulation comprises a QAM demodulation performed in accordance with ITU-T recommendation J.83B.

According to step 604, an optional decryption of the demodulated signal is performed. In a preferred embodiment, a CableCard device is used which encapsulates the proprietary encryption scheme used by the cable operator into a removable module.

According to step 606, an MPEG decoding of the signal is performed. It will be appreciated that the MPEG decoding of the signal may be performed according to various embodiments known to the skilled addressee. In preferred embodiments, MPEG-2 (H.262) and MPEG-4 (H.264) standards are used. In the preferred embodiment, the decode process will output not only the uncompressed video suitable for processing in step 608, but also information about how the original encoding was performed, which can then be used to simplify the encoding in step 610.

According to step 608, a processing of the signal is performed. It will be appreciated that this step may be optional. In a preferred embodiment, the processing comprises scaling of the picture to fit the resolution of a TV set to which it will be displayed on and further overlaying text and graphical elements which provide the user interface in response to commands from the user via the remote control.

According to step 610, an MPEG encoding of the signal is performed. It will be appreciated that the MPEG encoding of the signal may be performed according to various embodiments known to the skilled addressee. In one embodiment, an MPEG-2 encoding is used with encoding options chosen to minimize latency. In one embodiment this is achieved by encoding only I-pictures and P-pictures (i.e. not making use of B-pictures). Since the output bitrate is not significantly constrained, in comparison to other applications for MPEG-2, encoding algorithms which favour high quality at the expense of bitrate are suitable to be used.

According to step 612, an optional encryption of the signal is performed. Algorithms required to interwork with TV receiving equipments already installed in the home are implemented in a preferred embodiment.

According to step 614, a QAM modulation of the signal is performed. It will be appreciated that the QAM modulation of the signal may be performed according to various embodiments known to the skilled addressee. In a preferred embodiment the QAM modulation is performed in accordance with ITU-T recommendation J.83B, implemented using digital signal processing techniques to produce an intermediate frequency (IF) digital output to a digital to analog converter (DAC) and hence derive an analog IF signal.

According to step 616, an RF modulation of the signal is performed. It will be appreciated that the RF modulated signal may then be provided to the plurality of TV sets using the existing communication network. The RF modulation is achieved by mixing the intermediate frequency output from the QAM modulator with a local oscillator. The frequency of the local oscillator may be varied to generate the RF modulated signal on the desired channel frequency.

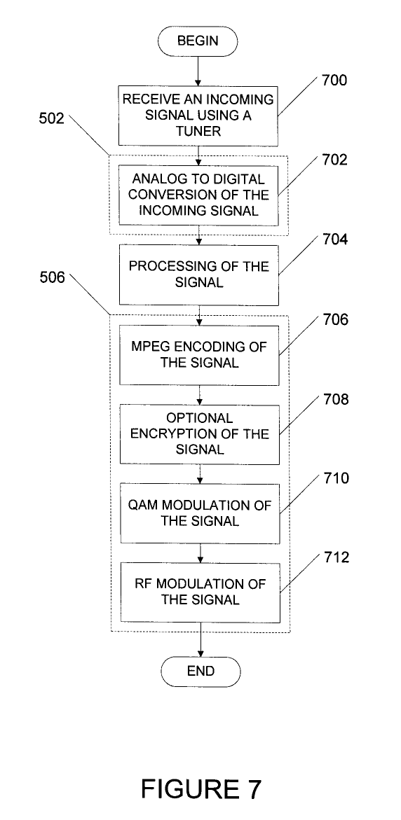

Now referring to FIG. 7, there is shown another embodiment which shows how the flexible router operates in the case where the incoming signal originates from an analog broadcast source such as cable.

According to step 700, an incoming signal is received from the tuner. As mentioned previously, the incoming signal originates from analog source.

According to step 702, an analog to digital conversion of the incoming signal is performed. The skilled addressee will appreciate that the analog to digital conversion may be performed according to various embodiments known to the skilled addressee. In a preferred embodiment standard parts are used to provide a digital output in BT.656 format, at a resolution of 720×480 pixels in a 4:2:2 YUV format.

According to step 704, a processing of the signal is performed. As mentioned previously, the processing of the signal may be optional and may be performed according to various embodiments. In a preferred embodiment, the processing comprises scaling of the picture to fit the resolution of a TV set to which it will be displayed on and further overlaying text and graphical elements which provide the user interface in response to commands from the user via the remote control.

According to step 706, an MPEG encoding of the signal is performed. It will be appreciated that the MPEG encoding of the signal may be performed according to various embodiments known to the skilled addressee. In one embodiment, an MPEG-2 encoding is used with encoding options chosen to minimize latency. In one embodiment this is achieved by encoding only I-pictures and P-pictures (i.e. not making use of B-pictures). Since the output bitrate is not significantly constrained, in comparison to other applications for MPEG-2, encoding algorithms which favour high quality at the expense of bitrate are suitable to be used.

According to step 708, an optional encryption of the signal is performed. Algorithms required to interwork with TV receiving equipments already installed in the home are implemented in a preferred embodiment.

According to step 710, a QAM modulation of the signal is performed. It will be appreciated by the skilled addressee that the QAM modulation of the signal may be performed according to various embodiments known to the skilled addressee. In a preferred embodiment the QAM modulation is performed in accordance with ITU-T recommendation J.83B, implemented using digital signal processing techniques to produce an intermediate frequency (IF) digital output to a digital to analog converter (DAC) and hence derive an analog IF signal.

According to step 712, an RF modulation of the signal is performed. The RF modulated signal is then provided to the plurality of TV sets using the existing communication network. The RF modulation is achieved by mixing the intermediate frequency output from the QAM modulator with a local oscillator. The frequency of the local oscillator may be varied to generate the RF modulated signal on the desired channel frequency.

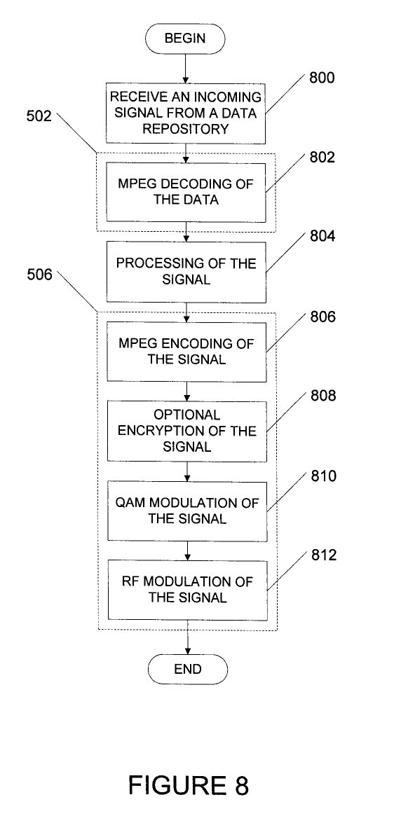

Now referring to FIG. 8, there is shown another embodiment which shows how the flexible router operates in the case where the incoming signal originates from a data repository (also referred to as a data storage unit).

According to step 800, an incoming signal is received from a data repository. It will be appreciated by the skilled addressee that the incoming signal may comprise data stored in various formats known to the skilled addressee. In one embodiment, the data is stored according to the MPEG standard. In a preferred embodiment the MPEG-4 AVC (H.264) format is used to minimize the amount of space consumed on the storage device. However it may be expedient to store data in the format in which it first arrived, in order to avoid the need to process the data during the storage operation; in this case, the data may be in one of many formats comprising MPEG-2, Windows™ Media, SMPTE VC-1, Flash™.

According to step 802, a decoding of the data is performed to yield uncompressed video. It will be appreciated that the decoding may be performed according to various embodiments known to the skilled addressee. In the preferred embodiment where the data is stored in MPEG format, a standard MPEG decoding process is performed. In the preferred embodiment, the decode process will output not only the uncompressed video suitable for processing in step 804, but also information about how the original encoding was performed, which can then be used to simplify the encoding in step 806.

According to step 804, a processing of the signal is performed. As mentioned previously, it will be appreciated that the processing of the signal may be optional. In a preferred embodiment, the processing comprises scaling of the picture to fit the resolution of a TV set to which it will be displayed on and further overlaying text and graphical elements which provide the user interface in response to commands from the user via the remote control.

According to step 806, an MPEG encoding of the signal is performed. It will be appreciated that the MPEG encoding of the signal may be performed according to various embodiments known to the skilled addressee. In one embodiment, an MPEG-2 encoding is used with encoding options chosen to minimize latency. In one embodiment this is achieved by encoding only I-pictures and P-pictures (i.e. not making use of B-pictures). Since the output bitrate is not significantly constrained, in comparison to other applications for MPEG-2, encoding algorithms which favour high quality at the expense of bitrate are suitable to be used.

According to step 808, an optional encryption of the signal is performed. Algorithms required to interwork with TV receiving equipments already installed in the home are implemented in a preferred embodiment.

According to step 810, a QAM modulating of the signal is performed. It will be appreciated that the QAM modulating of the signal may be performed according to various embodiments known to the skilled addressee. In a preferred embodiment the QAM modulation is performed in accordance with ITU-T recommendation J.83B, implemented using digital signal processing techniques to produce an intermediate frequency (IF) digital output to a digital to analog converter (DAC) and hence derive an analog IF signal.

According to step 812, an RF modulation of the signal is performed. It will be appreciated that the RF modulation of the signal may be performed according to various embodiments known to the skilled addressee. The RF modulated signal is then provided to the plurality of TV sets using the existing communication network. The RF modulation is achieved by mixing the intermediate frequency output from the QAM modulator with a local oscillator. The frequency of the local oscillator may be varied to generate the RF modulated signal on the desired channel frequency.

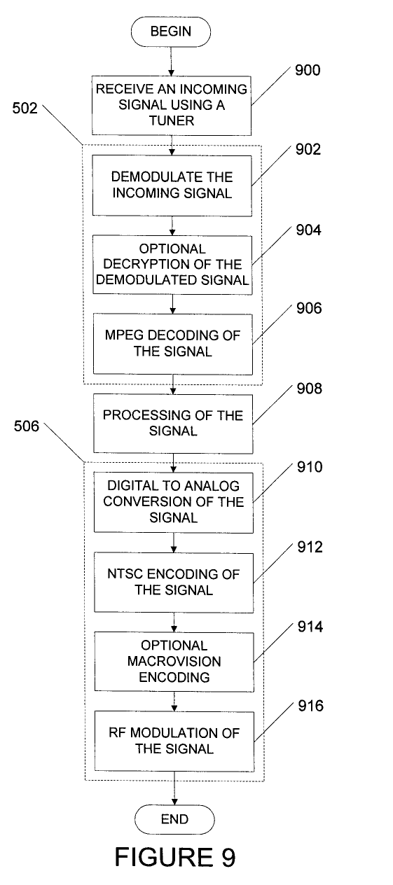

Now referring to FIG. 9, there is shown a further embodiment which shows how the flexible router operates in the case where the incoming signal originates from a digital broadcast source. In this embodiment, the plurality of TV sets comprises analog TVs.

According to step 900, an incoming signal is received using a tuner. As mentioned previously, the incoming signal originates from a digital broadcast source.

According to step 902, the incoming signal is demodulated. It will be appreciated that the demodulation is performed according to various embodiments known to the skilled addressee. In one embodiment, the demodulation comprises a QAM demodulation performed in accordance with ITU-T recommendation J.83B.

According to step 904, an optional decryption of the demodulated signal is performed. In a preferred embodiment, a CableCard device is used which encapsulates the proprietary encryption scheme used by the cable operator into a removable module.

According to step 906, an MPEG decoding of the signal is performed. It will be appreciated that the MPEG decoding may be performed according to various embodiments known to the skilled addressee. In preferred embodiments, MPEG-2 (H.262) and MPEG-4 (H.264) standards are used. In the preferred embodiment, the decode process will output not only the uncompressed video suitable for processing in step 608, but also information about how the original encoding was performed, which can then be used to simplify the encoding in step 610.

According to step 908, a processing of the signal is performed. As mentioned previously, the processing of the signal is optional. In a preferred embodiment, the processing comprises scaling of the picture to fit the resolution of a TV set to which it will be displayed on and further overlaying text and graphical elements which provide the user interface in response to commands from the user via the remote control.

According step 910, a digital to analog conversion of the signal is performed. It will be appreciated that the digital to analog conversion of the signal may be performed according to various embodiments known to the skilled addressee.

According to step 912, an NTSC encoding of the signal is performed. It will be appreciated that the NTSC encoding of the signal may be performed according to various embodiments known to the skilled addressee.

According to step 914, an optional encoding is performed to prevent unauthorized videotaping of the signal. In a preferred embodiment, the Macrovision process as described in U.S. Pat. No. 4,631,603, U.S. Pat. No. 4,577,216 and U.S. Pat. No. 4,819,098, the specifications of which are hereby incorporated by reference, may be used.

In a preferred embodiment, steps 910, 912 and 914 are performed using a single chip which is widely available from many manufacturers known to the skilled addressee.

According to step 916, an RF modulation of the signal is performed. It will be appreciated that the RF modulation of the signal may be performed according to various embodiments known to the skilled addressee. Moreover, it will be appreciated that the RF modulated signal is then provided to the plurality of TV sets using the existing communication network.

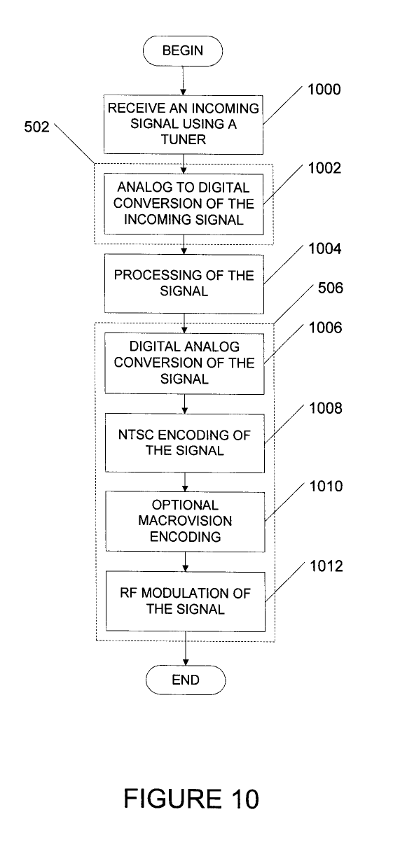

Now referring to FIG. 10, there is shown another embodiment which shows how the flexible router operates in the case where the incoming signal originates from an analog broadcast source and in the case where the plurality of TV sets comprises analog TV sets.

According to step 1000, an incoming signal is received using a tuner. As mentioned previously, the incoming signal originates from a broadcast source which is analog.

According to step 1002, an analog to digital conversion of the incoming signal is performed. It will be appreciated that the analog to digital conversion of the incoming signal may be performed according to various embodiments known to the skilled addressee. In a preferred embodiment standard parts are used to provide a digital output in BT.656 format, at a resolution of 720×480 pixels in a 4:2:2 YUV format.

According to step 1004, a processing of the signal is performed. It will be appreciated that the processing of the signal may be optional as mentioned earlier. In a preferred embodiment, the processing comprises scaling of the picture to fit the resolution of a TV set to which it will be displayed on and further overlaying text and graphical elements which provide the user interface in response to commands from the user via the remote control.

According to step 1006, a digital to analog conversion of the signal is performed. It will be appreciated that the digital to analog conversion of the signal may be performed according to various embodiments known to the skilled addressee.

According to step 1008, an NTSC encoding of the signal is performed. It will be appreciated that the NTSC encoding of the signal may be performed according to various embodiments known to the skilled addressee.

According to step 1010, an optional macrovision encoding is performed.

According to step 1012, an RF modulation of the signal is performed. It will be appreciated that the RF modulation of the signal may be performed according to various embodiments known to the skilled addressee.

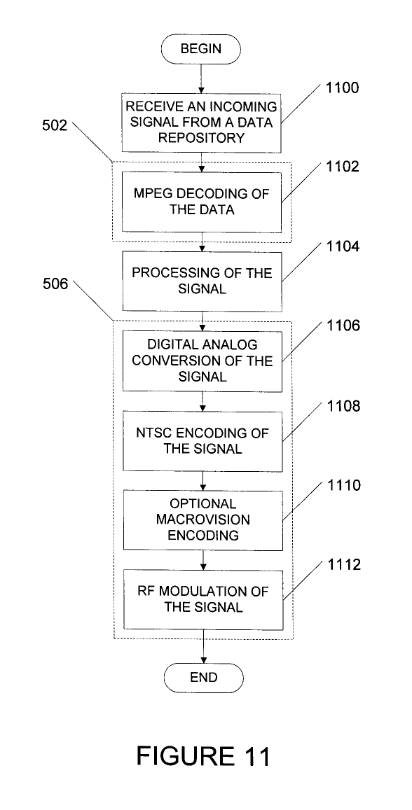

Now referring to FIG. 11, there is shown another embodiment which shows how the flexible router operates in the case where the incoming signal originates from a data repository and in the case where the plurality of TV sets comprises analog TV sets.

According to step 1100, an incoming signal is received from a data repository. It will be appreciated that the incoming signal may comprise data which is stored in the data repository according to various standards known to the skilled addressee. In one embodiment, the data is stored according to the MPEG standard. In a preferred embodiment the MPEG-4 AVC (H.264) format is used to minimize the amount of space consumed on the storage device. However it may be expedient to store data in the format in which it first arrived, in order to avoid the need to process the data during the storage operation; in this case, the data may be in one of many formats comprising MPEG-2, Windows™ Media, SMPTE VC-1, Flash™.

According to step 1102, a decoding of the data is performed to yield uncompressed video. It will be appreciated that the decoding may be performed according to various embodiments known to the skilled addressee. In the preferred embodiment where the data is stored in MPEG format, a standard MPEG decoding process is performed.

According to step 1104, a processing of the signal is performed. It will be appreciated that the processing of the signal is optional. In a preferred embodiment, the processing comprises scaling of the picture to fit the resolution of a TV set to which it will be displayed on and further overlaying text and graphical elements which provide the user interface in response to commands from the user via the remote control.

According to step 1106, a digital to analog conversion of the signal is performed. It will be appreciated that the digital to analog conversion of the signal may be performed according to various embodiments known to the skilled addressee.

According to step 1108, an NTSC encoding of the signal is performed. It will be appreciated that the NTSC encoding of the signal may be performed according to various embodiments known to the skilled addressee.

According to step 1110, an optional macrovision encoding is performed.

According to step 1112, an RF modulation of the signal is performed. It will be appreciated that the RF modulation of the signal may be performed according to various embodiments known to the skilled addressee. Following the RF modulation of the signal, the RF modulated signal is provided to the plurality of TV sets using the existing communication network.

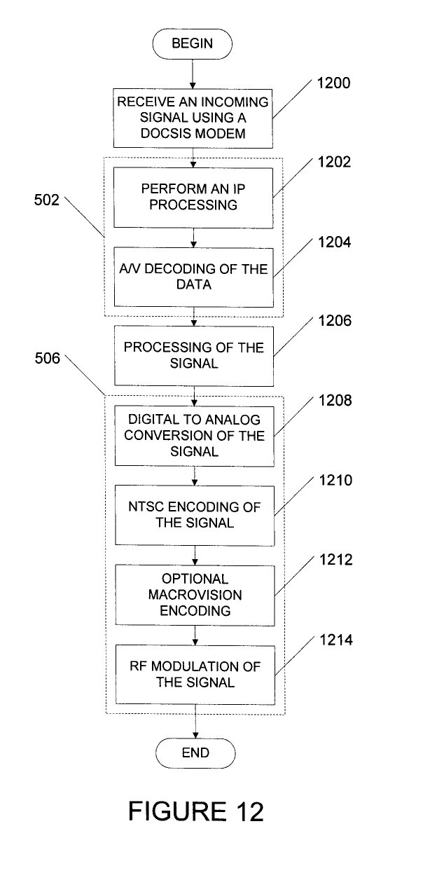

Now referring to FIG. 12, there is shown another embodiment which shows how the flexible router operates in the case where the incoming signal originates from a broadband source, such as the Internet, and in the case where the plurality of TV sets comprises analog TV sets.

According to step 1200, an incoming signal is received using a DOCSIS modem in one embodiment. Alternatively another type of modem may be used.

According to step 1202, an IP processing is performed. It will be appreciated that the IP processing may comprise various operations known to the skilled addressee. In particular the various operations may comprise using the IGMP protocol to support multicast services and RTSP protocol to support video-on-demand services. Alternatively many other embodiments are possible.

According to step 1204, an audio/video decoding of the data is performed. It will be appreciated that the audio/video decoding of the data may be performed according to various configurations depending on the type of audio/video data.

According to step 1206, a processing of the signal is performed. It will be appreciated that the processing of the signal is optional. In a preferred embodiment, the processing comprises scaling of the picture to fit the resolution of a TV set to which it will be displayed on and further overlaying text and graphical elements which provide the user interface in response to commands from the user via the remote control.

According to step 1208, a digital to analog conversion of the signal is performed. It will be appreciated that the digital to analog conversion of the signal may be performed according to various embodiments known to the skilled addressee.

According to step 1210, an NTSC encoding of the signal is performed. It will be appreciated that the NTSC encoding of the signal may be performed according to various embodiments known to the skilled addressee.

According to step 1212, an optional macrovision encoding is performed.

According to step 1214, an RF modulation of the signal is performed. It will be appreciated that the RF modulation of the signal is performed according to various embodiments known to the skilled addressee.

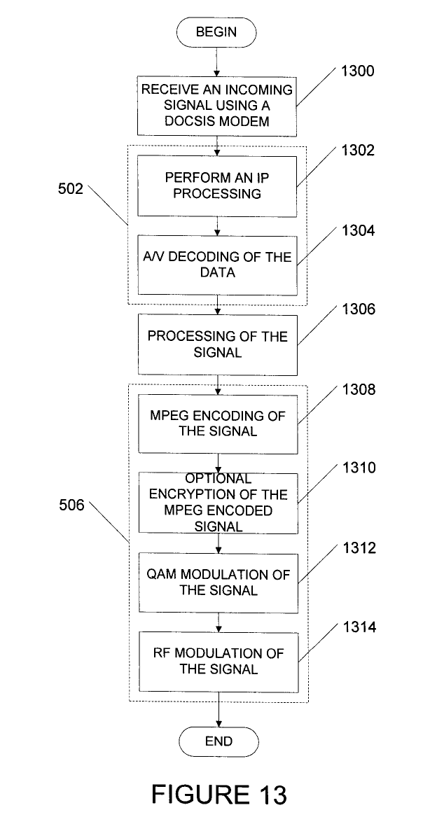

Now referring to FIG. 13, there is shown another embodiment which shows how the flexible router operates in the case where the incoming signal originates from a broadband source such, as the Internet, and in the case where the plurality of TV sets comprises digital TV sets.

According to step 1300, an incoming signal is received using a DOCSIS modem. Alternatively another type of modem may be used.

According to step 1302, an IP processing is performed. It will be appreciated that the IP processing may comprise various operations known to the skilled addressee. In particular the various operations may comprise using the IGMP protocol to support multicast services and RTSP protocol to support video-on-demand services. Alternatively many other embodiments are possible.

According to step 1304, an audio/video decoding of the data is performed. It will be appreciated that the audio/video decoding of the data may be performed according to various configurations depending on the type of audio/video data.

According to step 1306, a processing of the signal is performed. It will be appreciated that the processing of the signal is optional. In a preferred embodiment, the processing comprises scaling of the picture to fit the resolution of a TV set to which it will be displayed on and further overlaying text and graphical elements which provide the user interface in response to commands from the user via the remote control.

According to step 1308, an MPEG encoding of the signal is performed. It will be appreciated that the MPEG encoding of the signal may be performed according to various embodiments known to the skilled addressee. In one embodiment, an MPEG-2 encoding is used with encoding options chosen to minimize latency. In one embodiment this is achieved by encoding only I-pictures and P-pictures (i.e. not making use of B-pictures). Since the output bitrate is not significantly constrained, in comparison to other applications for MPEG-2, encoding algorithms which favour high quality at the expense of bitrate are suitable to be used.

According to step 1310, an optional encryption of the MPEG encoded signal is performed.

According to step 1312, a QAM modulation of the signal is performed. It will be appreciated that the QAM modulation of the signal may be performed according to various embodiments known to the skilled addressee. In a preferred embodiment the QAM modulation is performed in accordance with ITU-T recommendation J.83B, implemented using digital signal processing techniques to produce an intermediate frequency (IF) digital output to a digital to analog converter (DAC) and hence derive an analog IF signal.

According to step 1314, an RF modulation of the signal is performed. It will be appreciated that the RF modulation of the signal may be performed according to various embodiments known to the skilled addressee.

The skilled addressee will appreciate that the method and apparatus disclosed herein are of great advantages over the prior art. In fact, the method and apparatus disclosed herein enable a user to access a wide variety of content sources originating from both broadcast as well as broadband sources which is of great advantage over the prior art.

Moreover, it will be appreciated a user is capable of viewing these content sources over a large variety of TV sets notwithstanding the native standard of either the content or the equipment (TV Sets). An existing coax network may therefore be advantageously used to provide a video signal to a TV set of the plurality of TV sets. Moreover and because of the video processing unit, the flexible router may edit/amend a signal before providing it to the TV set of a user. The editing/amending of the signal may be of great interest in order to add advertising for instances to a video signal provided to a TV set.

The ability of being able to keep existing legacy equipment, such as set top boxes and televisions in operation while implementing advanced services and providing those televisions using the existing infrastructure with content originating from other sources such as broadband sources like the Internet is very advantageous over the prior art.

It will be appreciated by the skilled addressee that the flexible router disclosed may assign a viewing channel to a specific TV set depending on various considerations such as the technology of the TV set and the existing communication network. The user therefore becomes capable of viewing any type of content across the existing communication network by selecting a given channel in its own existing communication network which is of great advantage. As mentioned previously each channel may provide content originating from the broadcast source or a broadband source. It will be further appreciated that in one embodiment, a channel may comprise specific applications that can be viewed by at least one given TV set. Those applications may be selected from a group consisting of streaming content sites, social networking sites, dynamo music sites, energy management and monitoring applications, or the like. It will be appreciated that the applications may be selectively updated and maintained via a broadband network to deliver active content. While it will be appreciated that in some instances the applications may be manageable by the user, in some other instances some applications, as well as the resources that they control may be manageable by a service provider. It will be appreciated that the delivery of active content by the flexible router represents a significant departure from any browsing solution that involve static web pages since a TV set on which the active content is delivered does not need any operating system to operate which is of great advantage. Moreover, it will be appreciated that it may be possible to switch dynamically from one source to another. In fact, it will be appreciated that the switching may be performed by a user or alternatively by a remote provider who may then advantageously control what is viewed by a user. This may be used to provide ads.

In fact, an optional data storage unit may be provided to store advertisement data to include as well as any other multimedia content that may be delivered to the user. Moreover, the data storage unit may be advantageously used as a personal video recorder (PVR), as mentioned earlier, which may store, in digital form, data originating or not from an analog source which is also a great advantage.

Since the flexible router provides transcoding functions which translate video content from many different formats into a format best utilized by each television within the home, the service provider is able to significantly reduce bandwidth in sending a video signal to a consumer without replacing existing equipment already located in the consumer's home which is of great advantage.

Moreover, it will be appreciated by the skilled addressee that the method disclosed herein helps avoiding the necessity of an alternate transport mechanism, such as digital, wired, wireless, IP based or other, to deliver high definition and standard definition digital video to any TV sets at a house. The method takes advantage of the existing communication network to act as transport medium for digital and analog video, without the need for extended HDMI, component or S-video cables, and without requiring Ethernet modulation schemes or other adjustments.

It will be appreciated by the skilled addressee that a video signal is intended to comprise also an audio signal in the above.

Although the above description relates to specific embodiments as presently contemplated by the inventors, it will be understood that the invention in its broad aspect includes functional equivalents of the elements described herein.

1. A flexible router for providing a video signal to anyone of a plurality of TV sets, the flexible router comprising:
at least one demodulation unit, each of the at least one demodulation unit for receiving one of a broadband signal and a broadcast signal and for providing a corresponding demodulated video signal;
a modulating unit for modulating an incoming video signal into a video signal suitable for a given TV set; and
a switching unit for selecting a demodulated video signal from a given demodulation unit of the at least one demodulation unit and for providing the selected demodulated video signal to the modulating unit according to a selection signal.

2. The flexible router as claimed in claim 1, wherein said flexible router comprises a plurality of demodulation units, each of the plurality of demodulation units for receiving one of a broadband signal and a broadcast signal and for providing a corresponding demodulated video signal.

3. The flexible router as claimed in claim 1, further comprising a video processing unit for receiving the selected demodulated video from the switching unit and for processing the selected demodulated video to provide a video processed signal; further wherein said modulating unit modulates the video processed signal.

4. The flexible router as claimed in claim 3, further comprising a data storage unit for storing a plurality of video signals, further wherein said switching unit is used for selecting one of a demodulated video signal from a given demodulation unit of the at least one demodulation unit and a video signal from the data storage unit.

5. The flexible router as claimed in claim 4, further comprising a broadband data processing unit for receiving a broadband signal from a broadband source and providing a data signal to store to the data storage unit.

6. The flexible router as claimed in claim 4, further comprising a broadband data communication port connected to the broadband data processing unit, the broadband data communication port for providing broadband data to a processing unit.

7. The flexible router as claimed in claimed in claim 1, wherein said flexible router comprises a plurality of modulating units, each for modulating an incoming video signal into a corresponding video signal suitable for a given TV set; further wherein said switching unit is for selecting a demodulated video signal from a given demodulation unit of the at least one demodulation unit and for providing the selected demodulated video signal to a given modulating unit of the plurality of modulating units according to a selection signal.

8. The flexible router as claimed in claim 7, further comprising a plurality of video processing units, each for receiving the selected demodulated video from the switching unit and for processing the selected demodulated video to provide a video processed signal to a corresponding one of the plurality of modulating units.

9. The flexible router as claimed in claim 1, wherein said selection signal comprises a user selection signal.

10. A method for providing a video signal to anyone of a plurality of TV sets, the method comprising:
receiving an incoming signal;
processing the incoming signal to provide a video signal;
modulating the video signal to providing a modulated video signal; and
providing the modulated video signal to at least one of a plurality of TV sets.

11. The method as claimed in claim 10, wherein said processing of said incoming signal comprises providing a video signal and processing the provided video signal.

12. The method as claimed in claim 11, wherein said providing of said video signal comprises demodulating the incoming signal to provide said video signal.

13. The method as claimed in claim 10, wherein said incoming signal originates from a group consisting of a data storage unit, a broadband access and a broadcast access.

14. The method as claimed in claim 10, further comprising selecting a source for an incoming signal, further wherein said incoming signal is received from the selected source for the incoming signal.

15. The method as claimed in claim 10, wherein said providing of said modulated video signal to at least one of a plurality of TV sets is performed over an existing communication network.

16. The method as claimed in claim 10, wherein said modulating of said video signal to provide a modulated video signal comprises selecting a suitable modulating unit and providing said video signal to said selected suitable modulating unit.
